(19) United States
(12) Patent Application Publication
(10) Pub. No.: US 2007/0216232 A1
(43) Pub. Date: Sep. 20, 2007

(54) Multi-functional safety power supply switch of touch screen type

(76) Inventor: Li Feng, Shenzhen (CN)

Correspondence Address: ANNA WU, P.O. BOX 93286, CITY OF INDUSTRY, CA, 91715, US

(21) Appl. No.: 11/375,706

(22) Filed: Mar. 14, 2006

(51) Int. Cl. H01H 35/00

(52) U.S. Cl. 307/119

(57) ABSTRACT

The invention discloses a multi-function safety power supply switch of touch screen type. The switch includes a housing, a cover, a power supply input interface and a power supply output interface provided on the housing, a switching power source module provided in the housing, and a control circuit board connected electrically to the switching power source. A switch module is connected to the output interface of the control circuit board, the input terminal of the switch module is connected to the power supply input interface, and the output terminal of the switch module is connected to the power supply output interface. A touch screen connected electrically to the control circuit is provided on the cover, and a back-light source module is provided on the inner side of the touch screen. By using touch screen technique for controlling power consumption circuit with relay driven by weak signal, the possibility of touching high voltage by human body is thoroughly eliminated and the electrical power may be consumed more conveniently and safely. A back-light source module and a display screen can be additionally provided to the switch, so that a user can also see the room temperature and time when the power consumption circuit is turn on or off. This allows the switch to have more uses and be thoughtful to the user.

### TECHNICAL FIELD

The invention relates to power supply switch, more specifically, to a multi-functional safety power supply switch of touch screen type.

### BACKGROUND

In the prior art, most of the power supply switches having mechanical contact structure are used to make electrically conductive connection. A force should be directly applied to the key of the switch to turn it on or off. Because electrically conductive connection is realized by contacting mechanical contacts, degraded contact or excessive resistance may occur when a switch is used for too longer time, and its used life is rather short. There are a few power supply switches in which remote control or audio signal control is used. However, most of them have simple function only and cannot be used extensively for they are specially designed to fulfill certain task. Because no back-light is provided in a power supply switch, one may come across trouble when he or she wants to turn on or off it in the evening or at night, since it is difficult to find out accurately the position of the switch in that case.

In addition, no indication concerning date, clock, and temperature is presented on a commonly used switch may put the user to inconvenience. It may also be inconvenient to the user, if the information of date, time, and temperature can only be obtained by providing a calendar, a clock, and a thermometer.

### SUMMARY

In view of the defects of the existing switches, an object of the invention is to provide a multi-functional safety power supply switch of touch screen type. An existing commonly used switch can be remodeled as a multi-purpose and more thoughtful switch, which serves both decorative and practical functions.

In order to attain the above object, the invention provides the following technical scheme: a multi-functional safety power supply switch of touch screen type is designed, it includes a housing, a cover, a power supply input interface and a power supply output interface provided on the housing, a switching power source module, and a control circuit board connected electrically to the switching power source are further provided in the housing. A switch module is connected to the output interface of the control circuit board, the input and output terminals of the switch module are connected to the power supply input and output interfaces, respectively. A touch screen connected electrically to the control circuit is provided on the cover, and a back-light source module is provided on the inner side of the touch screen.

In the invention, a LCD clock display screen may be provided in the above-mentioned multi-function safety power supply switch of touch screen type. The LCD clock display screen is located between the back light source module and the touch screen and connected electrically with the control circuit board.

In the invention, a remote control receiver may be provided on the cover and connected electrically with the control circuit board.

In the above-mentioned multi-function safety power supply switch of touch screen type, a control IC is provided on the control circuit board, a crystal oscillator is connected to pins #15 and #16 of the control IC, a touch control circuit consisting of five 220K resistors and five switches K₁-K₅ is connected to the input control pins #7, #8, #9, #10, and #11 of the control IC, when said switches K₁-K₅ are turned on by being touched, the potential level of pins #7, #8, #9, #10, and #11 of the control IC is low because these pins are grounded through switches K₁-K₅, so that a potential transition signal is generated, and a transition of potential level of the output pins OUT₁-OUT₆ occurs under the control guided by the program of the control IC, the switch module is connected with the output pins of the control IC.

The switch module of the invention may be composed of control triode, LED, and relay connected electrically with each other.

The switch module of the invention may also be composed of control triode, LED, and SCR connected electrically with each other.

The back-light source module of the invention is composed of resistors R₁, R₂, triodes Q₁, Q₂, photosensitive resistor C_{S}, and LED connected electrically with each other.

When implementing the invention, a partition plate for separating high voltage circuit from low voltage circuit is provided between the control circuit board and the switching power source module.

The power supply output interface of the invention may be provided in one or more groups.

As compared with the prior art, the invention has the following distinct advantages: using touch screen technique, a relay (or SCR) can be driven by weak signal, then a power consumption circuit is controlled, therefore, the possibility of touching high voltage by human body is thoroughly eliminated and the electrical power may be consumed more conveniently and safely. Using light control principle, a back-light source module is adopted to provide a faint light source at night or in rayless place, so that a user can see clearly the position of the switch and the approximate positions of the furnishings. Adopting display function of existing electronic clock and perpetual calendar, the user can see the room temperature and time when the power consumption circuit is turn on or off. This allows the switch to have more uses and be thoughtful to the user. By adding remote control receiver, the switch may also be provided with remote control function.

### BRIEF DESCRIPTION OF THE DRAWINGS

The brief description of the drawings is as follows:

FIG. 1 is a rear view of the switch of the invention;

FIG. 2 is a sectional view of the switch, taken along a line A-A in FIG. 1;

FIG. 3 is a block diagram illustrating the control principle of the switch of the invention;

FIG. 4 is a circuit diagram of the control circuit of the switch of the invention;

FIG. 5 is a circuit diagram of the switching power source of the switch of the invention;

FIG. 6 is a circuit diagram of the back-light source of the switch of the invention; and

FIG. 7 shows the structural principle of the switch module of the switch of the invention.

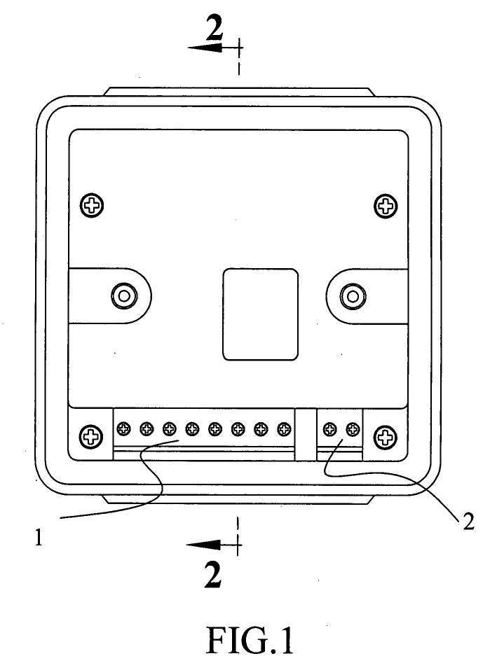

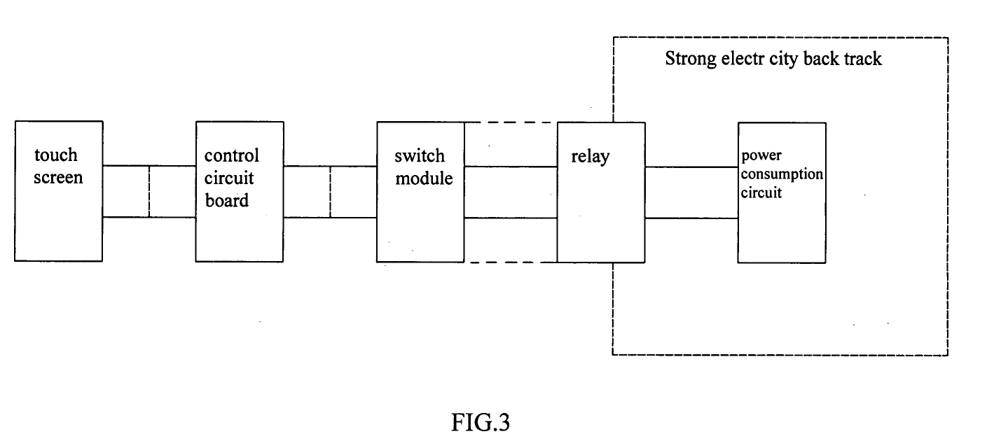

In FIGS. 1-7, reference numeral 1 denotes a power supply output interface, reference numeral 2 denotes a power supply input interface, reference numeral 3 denotes a switching power source module, reference numeral 4 denotes a partition plate for separating high voltage circuit and low voltage circuit, reference numeral 5 denotes a control circuit board, reference numeral 6 denotes a back-light source module, reference numeral 7 denotes a display screen, reference numeral 8 denotes a touch screen, reference numeral 9 denotes a cover, reference numeral 10 denotes a housing, and reference sign 11 denotes a switch module.

### DETAILED DESCRIPTION

The invention will be described in more detail through concrete implementations as follows.

Refer to FIGS. 1-5, the invention provides a multi-functional safety power supply switch of touch screen type, it includes a housing 10, and a cover 9, a power supply input interface 2 and a power supply output interface 1 are provided on one side of housing 10, a switching power source module 3, and a control circuit board connected electrically thereto are further provided in the housing 10. A switch module 11 is connected to the output interface of the control circuit board 5, the input and output terminals of the switch module 11 are connected to the power supply input interface 2, and the power supply output interface 1, respectively. The output interface 1 can be provided in one or more groups in case of necessity, so as to meet different requirement of controlling power supply connection. A touch screen 8 connected electrically to the control circuit 5 is provided on the cover 9, and a back-light source module 6 is provided on the inner side of the touch screen 8. When a touch screen (resistive type or capacitive type) 8 is touched by human body, an electrical signal is generated and transported to the IC circuit in the control board 5, then a signal is outputted from the IC circuit to control the switch module 11 to close or open the switch contacts in the switch module 11, and the goal of controlling power consumption circuit can be attained. The switch of the invention can be used more safely, because the high voltage circuit is thoroughly separated from the low voltage circuit.

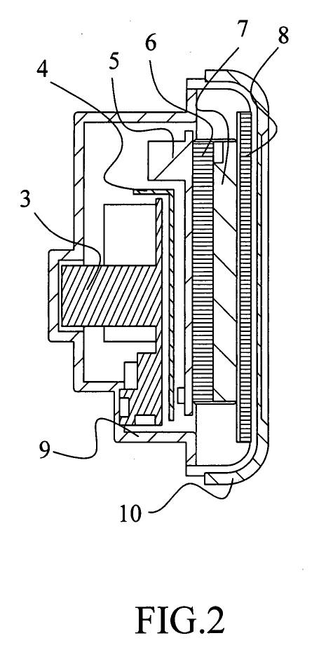

Refer to FIG. 2, a LCD clock display screen connected electrically with the control circuit board 5 is further provided between the back-light source module 6 and the touch screen 8. Processing circuit and display function of the existing electronic clock, perpetual calendar (temperature sensor and humidity sensor are self-contained, sensed signals are transported to the control IC, and displayed on display screen after processing) can be adopted. The LCD screen 7 can be rationally designed to enlarge characters, so as to fit indoor usage. The area of the touch screen is demarcated definitely, and it acts instantly upon being touched. The user can see the room temperature and time at any moment when the power consumption circuit is turn on or off. This allows the switch to have more uses and be thoughtful to the user.

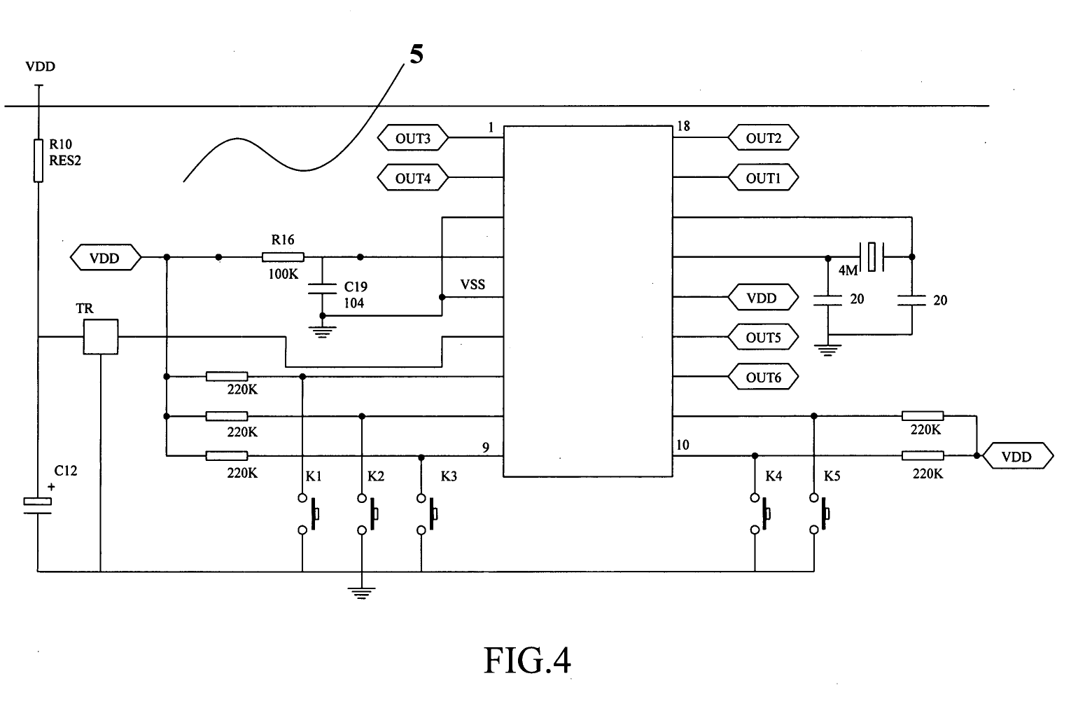

Refer to FIG. 4, a remote control receiver electrically connected to the control circuit board 5 may be provided on the cover 9. By adding remote control receiver, the on/off action of a switch may be controlled remotely. A remote control receiver of wireless or IR receiving type may be used. As such a remote control receiver pertains to the prior art, a detailed description is omitted. A wireless remote control receiver consisting of R10, C21 and IR is shown in FIG. 4.

Refer to FIG. 4, a control IC is provided on the control circuit board 5, a crystal oscillator is connected to pins #15 and #16 of the control IC, a touch control circuit consisting of five 220K resistors and five switches K₁-K₅ is connected to the input control pins #7, #8, #9, #10, and #11 of the control IC. When the switches K₁-K₅ are turned on by being touched, the potential level of pins #7, #8, #9, #10, and #11 is low, because these pins are grounded through switches K₁-K₅, so that a potential level transition signal is generated, and a transition of potential level of the output pins OUT₁-OUT₆ occurs under the control guided by the program of the control IC, the switch module is connected with the output pins of the control IC. In the original state of the control IC, the potential level of the output pins is low. When a user touches the touch screen of the product, a conduction signal is generated, and then a control signal is generated in the control IC. Thus, a potential level transition from low to high will occur at the output pins of the control IC, and the switch module 11 is driven to act. When the region of the switches K₁-K₅ is touched once again, upon control guided by the control IC, a low potential level is outputted from the output pins thereof, and the switch module does not work.

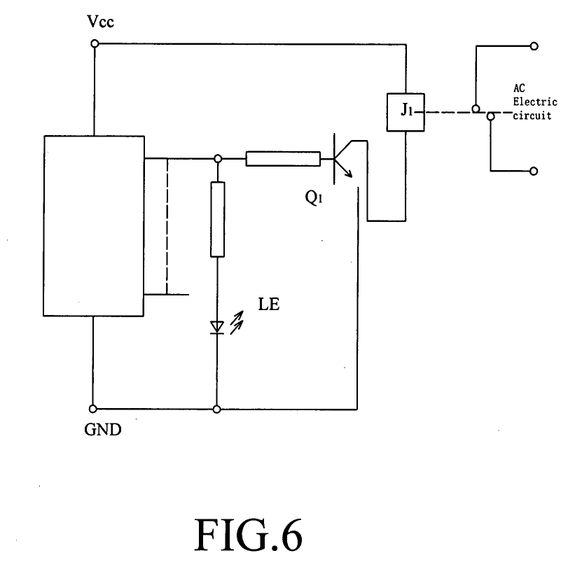

Refer to FIG. 6, the switch module is composed of a control triode Q₁, a LED, and a relay J₁ connected electrically with each other. The switch module may also be composed of a control triode Q₁, a LED, and a SCR connected electrically with each other. The switch module may further be realized by using other contactless electronic switch. When the switch of the invention turns on, the high potential level signal outputted from the control IC propagates in two paths: in one path, the LED is lightened to indicate the ON state of the switch of the invention, in another path, the control triode Q₁ conducts upon providing a voltage to its base, then a current flows in the coil of the relay J1 to close its make-contact (or, equivalently, a SCR is conducted), and the power consumption circuit turns on and can be used. When the control IC outputs a low potential level, Q₁ is cut off because no potential is applied to the base, the make-contact of the relay is in its open position (or, equivalently, a SCR is cut off), and the power consumption circuit cannot be used since no current passes through it. At the same time, the LED is not lightened, which indicates the OFF state of the switch of the invention.

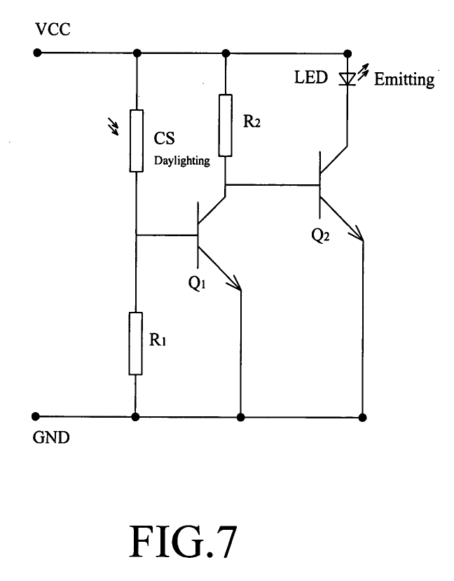

Refer to FIG. 7, the back-light source module is composed of resistors R₁, R₂, triodes Q₁, Q₂, a photosensitive resistor C_{S}, and a LED connected electrically with each other. When the indoor illumination is enough, C_{S} is in its low resistance state, upon potential division between C_{S} and R₁, Q₁ is in its conduction state because a conducting potential is applied to its base. Then the base potential of Q₂ is low, because it is limited by the low potential of the collector of Q₁ when it is conducted. The LED of the back-light source does not work since Q₂ is in its cut off state and no current flows through the LED.

On the contrary, when the indoor illumination is insufficient, C_{S} is in its high resistance state, upon potential division between C_{S} and R₁, Q₁ is in its cut off state because its base potential is too low. At this time a current path from V_{CC} through R₂ and the base-emitter of Q₂ is formed, Q₂ is conducted, a current path from VCC through LED and the collector-emitter of Q₂ is formed, and LED is lightened. Therefore, a faint light is emitted from the switch of the invention when an insufficient indoor illumination occurs. The user is thereby capable of knowing the position of the switch and the time, temperature, etc. Accident will not happen because the user can also see the appliances existing in a certain region of the room via faint light. Light sensing section may be composed of photosensitive resistor or other light controlling part, and the light emitting section may be composed of LED and light guiding plate or other light emitting source component.

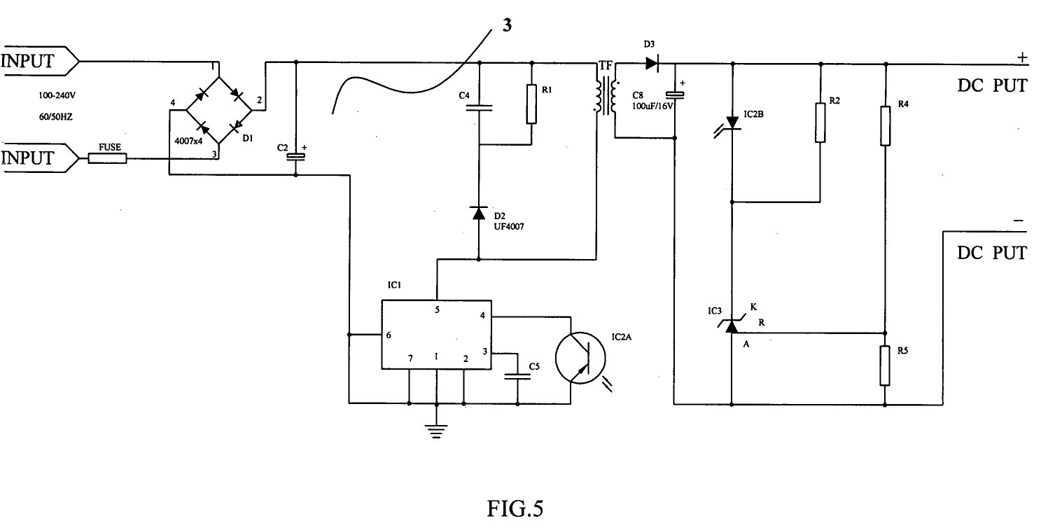

Refer to FIG. 5, the switching power source module is composed of an input rectifying and filtering circuit, a control integrated circuit IC1, an oscillator and transformer circuit, a photoelectric coupling and feedback circuit and sampling circuit, and an output rectifying and filtering circuit. The model of IC1 is CP1002IC or DL1001IC.

The principle of operation of the switching power source is described as follows. First, the inputted AC 100-240V voltage is changed into a DC high voltage through the input rectifying and filtering circuit D₁, C₂. One end of the primary coil of the high-frequency transformer TF is connected to the positive end of the rectifying and filtering circuit, and the other end of TF is connected to pin #5 of IC1. IC1 and the primary coil of TF constitute a high-frequency oscillating circuit. The DC high voltage is then changed by the high-frequency oscillating circuit into an AC low voltage at the secondary coil of TF. Finally, the AC low voltage is changed into a DC 3.3V through the output rectifying and filtering circuit D₃, C₈.

When the output voltage 3.3V increases, upon sampling by the sampling circuit composed of R₄, R₅, and IC₃, the current passing IC_{2B} increases, and the luminance of IC_{2B} increases. IC_{2A} and IC_{2B} constitute a photoelectric coupling and feedback circuit, and the collector of IC_{2A} is connected to pin #4 of IC₁. The increasing luminance of IC_{2B} results in decreasing the potential at pin #4 of IC, and increasing the current flows therein. Thus, the inner circuit of IC, is adjusted to lower the oscillating frequency, and the potential of the secondary coil of TF is lowered accordingly. On the contrary, when the output voltage 3.3V decreases, under the control of R₄, R₅, and IC₃, the current passing through IC_{2B} decreases, and the luminance thereof decreases. The feedback of the decreasing luminance of IC_{2B} to pin #4 of IC, results in increasing the oscillating frequency controlled by the inner circuit of IC1. Then the potential of the secondary coil of TF as well as the output voltage of the output rectifying and filtering circuit is heightened. The output voltage is then kept to a stabilized value of 3.3V.

A touch screen technology is adopted in the invention to control a relay (or SCR) by weak signal, then the power consumption circuit is controlled, therefore, the possibility of touching high voltage by human body is thoroughly eliminated and the electrical power may be consumed more conveniently and safely.

By adopting back-light source technology and light control principle, a faint light source is provided at night or at a dim place, so that a user can see clearly the position of the switch and the approximate positions of the furnishings in the room. Adopting display function of the existing electronic clock, perpetual calendar, the user can see the room temperature and time when the power consumption circuit is turn on or off. This allows the switch of the invention to have more uses and be thoughtful to the user. By adding remote control receiver, the switch may also have remote control function. Using switching power source technology, an inner power source is provided for the circuits of the switch of the invention. The inner power source can be used in the range of AC 90-270V, and normal work of the other modules is ensured. A multi-layer structure is adopted in designing the switch of the invention, and the separation of high voltage circuit and low voltage circuit is helpful in conveniently and safely installing.

In the structural design, the relationship between high voltage and low voltage has been fully considered for ensuring the safety of the product. (The output interfaces of the switch may be added selectively, and a user can connect electrical appliance to the switch having several output interfaces.)

What is claimed is:

1. A multi-function safety power supply switch of touch screen type including a housing, a cover, a power supply input interface and a power supply output interface provided on said housing, characterizing in that said multi-function safety power supply switch further comprising:
a switching power source module provided in said housing;
a control circuit board connected electrically to said switching power source module;
a switch module connected to the output interface of said control circuit board, and the input and the output terminals thereof are connected to said power supply input and output interfaces, respectively;
a touch screen provided on said cover and connected electrically to said control circuit; and
a back-light source module provided on the inner side of said touch screen.

2. The multi-function safety power supply switch of touch screen type according to claim 1, wherein further comprising a LCD clock display screen provided between said back-light source module and said touch screen, and connected electrically with said control circuit board.

3. The multi-function safety power supply switch of touch screen type according to claim 2, wherein further comprising a remote control receiver provided on said cover and connected electrically with said control circuit board.

4. The multi-function safety power supply switch of touch screen type according to claim 2, wherein a control IC is provided on said control circuit board, a crystal oscillator is connected to the pins #15 and #16 of said control IC, a touch control circuit consisting of five 220K resistors and five switches K₁-K₅ is connected to the input control pins #7, #8, #9, #10, and #11 of said control IC, when said switches K₁-K₅ are turned on by being touched, the potential levels at pins #7, #8, #9, #10, and #11 are low because these pins are grounded through switches K₁-K₅, so that a potential level transition signal is generated, and transition of potential level at the output terminals OUT₁-OUT₆ occurs under the control introduced by the program of said control IC, said switch module is connected with said output pins of said control IC.

5. The multi-function safety power supply switch of touch screen type according to claim 4, wherein said switch module is composed of control triode, LED, and relay connected electrically with each other.

6. The multi-function safety power supply switch of touch screen type according to claim 4, wherein said switch module is composed of control triode, LED, and SCR connected electrically with each other.

7. The multi-function safety power supply switch of touch screen type according to claim 4, wherein said back-light source module is composed of resistors R₁, R₂, triodes Q₁, Q₂, photosensitive resistor C_{S}, and LED connected electrically with each other.

8. The multi-function safety power supply switch of touch screen type according to claim 4, wherein a partition plate for separating high voltage part from low voltage part is provided between said control circuit board and said switching power source module

9. The multi-function safety power supply switch of touch screen type according to claim 8, wherein said power supply output interface may be provided in one or more groups.
